(19) United States
(12) Patent Application Publication
(10) Pub. No.: US 2007/0255476 A1
(43) Pub. Date: Nov. 1, 2007

(54) VEHICLE CONTROL DEVICE, AND METHOD OF CONTROLLING A VEHICLE

(75) Inventor: Hideki TAKAMATSU, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/687,125

(22) Filed: Mar. 16, 2007

(30) Foreign Application Priority Data
Apr. 28, 2006 (JP) 2006-126217

(51) Int. Cl. B60T 8/00

(52) U.S. Cl. 701/78

(57) ABSTRACT

An ECU executes a program that includes the step of setting a target deceleration of an operation vehicle on the basis of the amount of operation of a brake pedal, the step of dividing the target deceleration into a first deceleration caused by the braking force of brake devices and a second deceleration caused by the braking force of a power train, the step of controlling the brake devices to realize the first deceleration, the step of setting a speed change ratio of a belt type continuously variable transmission on the basis of the second deceleration, and the step of controlling the belt type continuously variable transmission to achieve the set speed change ratio.

### INCORPORATION BY REFERENCE

The disclosure of Japanese Patent Application No. 2006-126217 filed on Apr. 28, 2006 including the specification, drawings and abstract is incorporated herein by reference in its entirety.

### BACKGROUND OF THE INVENTION

1. Field of the Invention

The invention relates to a vehicle control device, and a method of controlling a vehicle. In particular the invention relates to a technology for controlling the deceleration of a vehicle via the power train and a braking mechanism that restrains the rotation of wheels by friction force.

2. Description of the Related Art

In hybrid motor vehicles and electric motor vehicles that are equipped with a motor-generator as a power source, regenerative power generation is performed through the use of the motor-generator during deceleration, whereby the kinetic energy of the vehicle is converted into electric energy, and is thus recovered. When regenerative power generation is performed, the motor-generator exerts a braking force on the vehicle. In addition, the braking force exerted by a foot brake that restrains the rotation of the wheels through the use of friction force generated by operating a brake pedal can also act on the vehicle. Therefore, with respect to the braking force required for the vehicle as a whole, it is necessary to take into the account the division between the braking force caused by the foot brake and the braking force caused by the motor-generator.

Japanese Patent Application Publication No. JP-A-2002-95108 discloses a braking force control device for a vehicle that is capable of maximizing the regenerative efficiency of the whole vehicle. The vehicle has regenerative braking devices and friction braking devices on the front wheels and the rear wheels. On the basis of a driver's requested braking amount and a predetermined front-rear wheel braking force division ratio, a braking force control device of this vehicle computes target braking forces for the front wheels and the rear wheels so that with regard to both the front wheels and the rear wheels, braking force is generated with priority given to the regenerative braking devices over the friction braking devices, and then controls the braking forces of the front wheels and the rear wheels to achieve the target braking forces of the front wheels and the rear wheels.

According to the braking force control device described in this publication, target braking forces for the front wheels and the rear wheels are computed on the basis of the driver's requested braking amount and the predetermined front-rear wheel braking force division ratio, and braking force is generated with priority given to the regenerative braking devices over the friction braking devices, with regard to both the front wheels and the rear wheels. Therefore, the braking forces of the front wheels and the rear wheels are controlled to the target braking forces of the front wheels and the rear wheels. Therefore, it is possible to control the braking force of the whole vehicle corresponding to the driver's requested braking amount, and to control the braking force division ratio between the front and rear wheels to a predetermined front-rear wheels braking force division ratio, and to optimally actuate the regenerative braking devices and the friction braking devices of the front wheels and the rear wheels. In consequence, the regenerative efficiency of the whole vehicle is controlled to a maximum degree, and the fuel economy can be further improved over the related art.

However, the braking force control device described in Japanese Patent Application Publication No. JP-A-2002-95108 is not applicable to a vehicle that does not have such an appliance as a motor generator capable of performing a regenerative electric power generation, or the like. Therefore, vehicles that do not have such an appliance as a motor-generator or the like must be decelerated by using only a foot brake. In this case, the kinetic energy is converted into heat energy and is thus dissipated by the foot brake, that is, energy is discarded.

### SUMMARY OF THE INVENTION

The invention provides a control device for a vehicle that is capable of reducing the energy that is dissipated as heat energy during deceleration.

A control device for a vehicle in accordance with a first aspect of the invention controls a vehicle having a power train that transmits drive force output from a power source to a wheel via a transmission, and a braking mechanism that restrains rotation of the wheel by friction force. The control device includes: a setting device for setting a physical amount that represents a degree of deceleration of the vehicle, in accordance with an operation of a driver; a division device for dividing the physical amount set by the setting device into a first physical amount that represents the degree of deceleration of the vehicle caused by the braking mechanism and a second physical amount that represents the degree of deceleration of the vehicle caused by the power train; a first control portion for controlling the braking mechanism to satisfy the first physical amount; and a second control portion for controlling the transmission to satisfy the second physical amount.

In this construction, the physical amount that represents the degree of deceleration of the vehicle is set in accordance with the driver's operation. The set physical amount is divided into the first physical amount that represents the degree of deceleration of the vehicle caused by the braking mechanism, and the second physical amount that represents the degree of deceleration of the vehicle caused by the power train. The braking mechanism is controlled to satisfy the first physical amount, and the transmission is controlled to satisfy the second physical amount. Therefore, the vehicle can be decelerated at a desired degree of deceleration through the use of both the braking mechanism and the power train. Hence, the braking force that the braking mechanism needs to generate may be reduced in comparison with the case where the vehicle is decelerated through the use of only the braking mechanism. Consequently, a control device for a vehicle that is capable of reducing the energy that is dissipated as heat energy during deceleration can be provided.

The second control portion may include a device for controlling the transmission to achieve a speed change ratio that satisfies the second physical amount.

In this construction, the transmission is controlled to achieve the speed change ratio that satisfies the second physical amount. Therefore, the rotation resistance in the power train may be increased. Hence, braking force can be generated by the power train without the need to provide a special device.

The automatic transmission may be a continuously variable transmission.

In this construction, the degree of deceleration of the vehicle caused by the power train may be accurately adjusted through the use of a continuously variable transmission that steplessly adjusts the speed change ratio.

The power source may be an internal combustion engine. The control device may further include a stop device for stopping fuel supply in the internal combustion engine if rotation speed of the internal combustion engine is greater than or equal to a predetermined value.

In this construction, the fuel supply is stopped if the rotation speed of the internal combustion engine is greater than or equal to the predetermined value. Therefore, the fuel economy can be improved.

The division device may include a device for dividing the physical amount set by the setting device into the first physical amount and the second physical amount so that the degree of deceleration of the vehicle caused by the braking mechanism becomes smaller than the degree of deceleration of the vehicle caused by the power train, and then dividing the physical amount set by the setting device into the first physical amount and the second physical amount so that the degree of deceleration of the vehicle caused by the braking mechanism is increased while the degree of deceleration of the vehicle caused by the power train is decreased.

In this construction, the physical amount set by the setting device is divided into the first physical amount and the second physical amount so that the degree of deceleration of the vehicle caused by the braking mechanism becomes smaller than the degree of deceleration of the vehicle caused by the power train. After that, the physical amount set by the setting device is divided into the first physical amount and the second physical amount so that the degree of deceleration of the vehicle caused by the braking mechanism is increased as the degree of deceleration of the vehicle caused by the power train is decreased. Therefore, immediately after the operation by the driver is performed, the vehicle may be promptly decelerated by increasing the braking force of the braking device that is good in responsiveness. After that, when the vehicle is decelerated, the braking force of the braking device is decreased and, instead, the braking force of the power train is increased so that the energy dissipated as heat energy by the braking device is reduced.

A second aspect of the invention relates to a control method for a vehicle. The control method includes:

setting a physical amount that represents a degree of deceleration of the vehicle, in accordance with an operation of a driver;

dividing the physical amount set into a first physical amount that represents the degree of deceleration of the vehicle caused by a braking mechanism that restrains rotation of a wheel by using friction force, and a second physical amount that represents the degree of deceleration of the vehicle caused by a power train that transmits drive force output from a power source to the wheel via a transmission;

controlling the braking mechanism to satisfy the first physical amount; and

controlling the transmission to satisfy the second physical amount.

In this construction, the physical amount that represents the degree of deceleration of the vehicle is set in accordance with the driver's operation. The set physical amount is divided into the first physical amount that represents the degree of deceleration of the vehicle caused by the braking mechanism, and the second physical amount that represents the degree of deceleration of the vehicle caused by the power train. The braking mechanism is controlled to satisfy the first physical amount, and the transmission is controlled to satisfy the second physical amount. Therefore, the vehicle can be decelerated at a desired degree of deceleration through the use of both the braking mechanism and the power train. Hence, the braking force that the braking mechanism needs to generate may be reduced in comparison with the case where the vehicle is decelerated through the use of only the braking mechanism. Consequently, a method for controlling a vehicle that reduces the energy that is dissipated as heat energy during deceleration can be provided.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a skeleton diagram of a vehicle equipped with a control device in accordance with an embodiment of the invention;

FIG. 2 is a control block diagram showing the control device in accordance with the embodiment of the invention;

FIG. 3 is a part of a diagram showing a hydraulic control circuit that is controlled by the control device in accordance with the embodiment of the invention;

FIG. 4 is a part of a diagram showing the hydraulic control circuit that is controlled by the control device in accordance with the embodiment of the invention;

FIG, 5 is a part of a diagram showing the hydraulic control circuit that is controlled by the control device in accordance with the embodiment of the invention;

FIG. 6 is a control block diagram showing an ECU shown in FIG. 2;

FIG. 7 is a diagram showing a first deceleration caused by brake devices, and a second deceleration caused by a power train;

FIG. 8 is a diagram showing target deceleration and actual deceleration;

FIG. 9 is a diagram showing target deceleration and actual deceleration; and

FIG. 10 is a flowchart showing a control structure of a program executed by an ECU of a control device in accordance with an embodiment of the invention.

### DETAILED DESCRIPTION OF THE PREFERRED EMBODIMENTS

Embodiments of the invention will be described hereinafter with reference to the drawings. In the following description, the same component parts are affixed with the same reference characters. The names and functions those component parts are also the same. Therefore, detailed descriptions thereof will not be repeated.

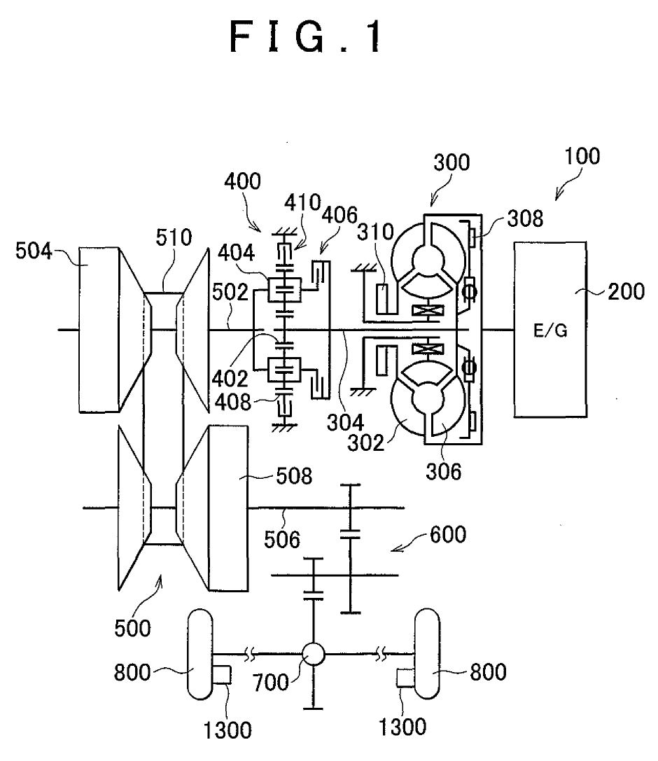

With reference to FIG. 1, a vehicle equipped with a control device in accordance with an embodiment of the invention will be described. Output of an engine 200 of a power train 100 mounted in the vehicle is input to a belt type continuously variable transmission 500 via a torque converter 300 and a forward-reverse switching device 400. The output of the belt type continuously variable transmission 500 is transmitted to a reduction gear 600 and a differential gear device 700, and is thereby divided to left and right driven wheels 800. The rotation of the driven wheels 800 is restrained by brake devices 1300. Each brake device 1300 restrains the rotation of a corresponding one of the driven wheels 800 by friction force.

The power train 100 is controlled by an ECU (Electronic Control Unit) 900 described below. The control device in accordance with the embodiment is realized by, for example, a program that is executed by the ECU 900. In addition, instead of the belt type continuously variable transmission 500, other types of transmissions, such as a toroidal type continuously variable transmission or the like, may be used.

The torque converter 300 is constructed of a pump impeller 302 linked to the crankshaft of the engine 200, and a turbine impeller 306 linked to the forward-reverse travel device 400 via a turbine shaft 304. A lockup clutch 308 is provided between the pump impeller 302 and the turbine impeller 306. The lockup clutch 308 is engaged or released by switching the oil pressure supply to an engagement-side oil chamber and a release-side oil chamber.

By completely engaging the lockup clutch 308, the pump impeller 302 and the turbine impeller 306 are integrally rotated together. The pump impeller 302 is provided with a mechanical oil pump 310 that generates oil pressure for controlling the shift of the belt type continuously variable transmission 500, and generates a belt clamping pressure, and supplies lubricating oil to various portions.

The forward-reverse switching device 400 is constructed of a double-pinion type planetary gear device. The turbine shaft 304 of the torque converter 300 is linked to a sun gear 402. An input shaft 502 of the belt type continuously variable transmission 500 is linked to a carrier 404. The carrier 404 and the sun gear 402 are linked via a forward clutch 406. A ring gear 408 is fixed to a housing via a reverse brake 410. Each of the forward clutch 40 and the reverse brake 410 is put into friction engagement by a hydraulic cylinder. The input rotation speed of the forward clutch 406 is the same as the rotation speed of the turbine shaft 304, that is, the turbine rotation speed NT.

When the forward clutch 406 is engaged and the reverse brake 410 is released, the forward-reverse switching device 400 allows forward movement of the vehicle. Thus, drive force in the forward travel direction is transmitted to the belt type continuously variable transmission 500. When the reverse brake 410 is engaged and the forward clutch 406 is released, the forward-reverse switching device 400 allows reverse movement of the vehicle. Thus, the input shaft 502 is rotated in a direction opposite to the rotation direction of the turbine shaft 304. Due to this, the drive force in the reverse direction is transmitted to the belt type continuously variable transmission 500. When the forward clutch 406 and the reverse brake 410 are both released, the forward-reverse switching device 400 assumes a neutral state and power transmission is shut off.

The belt type continuously variable transmission 500 is constructed of a primary pulley 504 provided on the input shaft 502, a secondary pulley 508 provided on an output shaft 506, and a transmission belt 510 mounted on the pulleys. Using the friction forces between the transmission belt 510 and the pulleys, the power transmission is performed.

Each pulley is constructed of a hydraulic cylinder so that the groove width thereof is variable. By controlling the oil pressure of the hydraulic cylinder of the primary pulley 504, the groove width of each pulley is changed. In this manner, the pulley contact diameters of the transmission belt 510 are altered, and the speed change ratio GR (=primary pulley rotation speed NIN/secondary pulley rotation speed NOUT) is continuously changed.

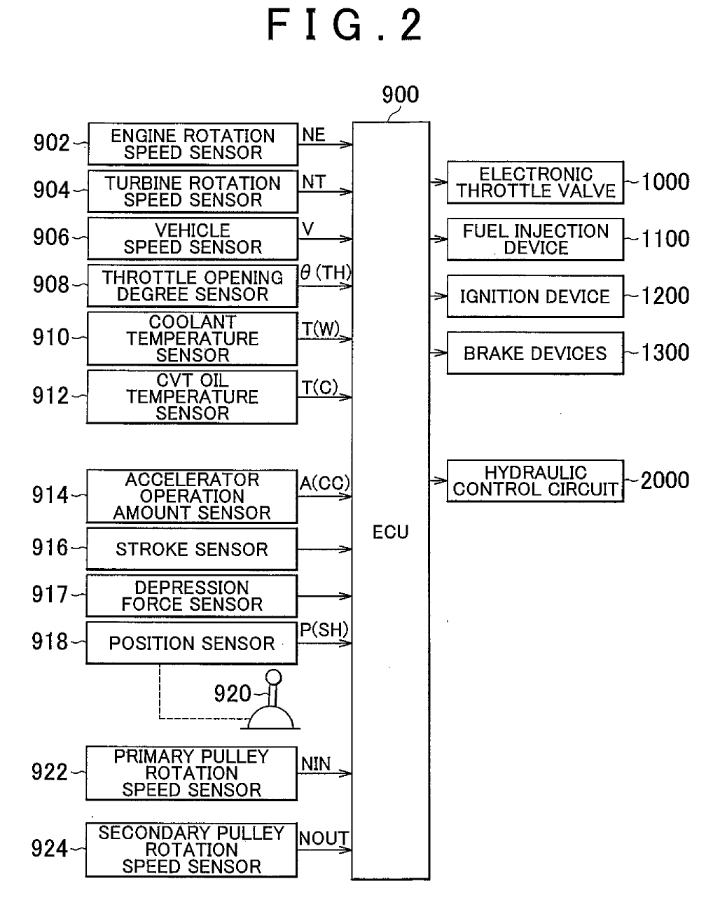

As shown in FIG. 2, various sensors are connected to the ECU 900, including an engine rotation speed sensor 902, a turbine rotation speed sensor 904, a vehicle speed sensor 906, a throttle opening degree sensor 908, a coolant temperature sensor 910, an CVT oil temperature sensor 912, an accelerator operation amount sensor 914, a stroke sensor 916, a depression force sensor 917, a position sensor 918, a primary pulley rotation speed sensor 922, and a secondary pulley rotation speed sensor 924.

The engine rotational speed sensor 902 detects the rotational speed (engine rotation speed) NE of the engine 200. The turbine rotational speed sensor 904 detects the rotational speed (turbine rotation speed) NT of the turbine shaft 304. The vehicle speed sensor 906 detects the vehicle speed V. The throttle opening degree sensor 908 detects the degree of opening θ (TH) of an electronic throttle valve. The coolant temperature sensor 910 detects the coolant temperature T(W) of the engine 200. The CVT oil temperature sensor 912 detects the oil temperature T(C) of the belt type continuously variable transmission 500 and the like. The accelerator operation amount sensor 914 detects the amount of depression A(CC) of an accelerator pedal. The stroke sensor 916 detects the amount of operation (amount of stroke) of a brake pedal. The depression force sensor 917 detects the depression force of the brake pedal (the force with which a driver depresses the brake pedal). The position sensor 918 detects the position P(SH) of a shift lever 920 by discriminating whether a contact provided at a position corresponding to the shift position is on or off. The primary pulley rotation speed sensor 922 detects the rotation speed NTN of the primary pulley 504. The secondary pulley rotation speed sensor 924 detects the rotation speed NOUT of the secondary pulley 508. A signal of each of the sensors representing a result of detection is sent to the ECU 900. The turbine rotation speed NT is equal to the primary pulley rotation speed NIN during the forward movement of the vehicle when the forward clutch 406 is engaged. The vehicle speed V corresponds to the secondary pulley rotation speed NOUT. Therefore, when the vehicle is stopped and the forward clutch 406 is engaged, the turbine rotation speed NT is 0.

The ECU 900 includes a CPU (Central Processing Unit), a memory, an input/output interface, etc. The CPU performs signal processing in accordance with programs stored in the memory. In this manner, an output control of the engine 200, a shift control of the belt type continuously variable transmission 500, a belt clamping pressure control, an engagement/release control of the forward clutch 406, an engagement/release control of the reverse brake 410, etc. may be executed.

The output control of the engine 200 is performed via an electronic throttle valve 1000, a fuel injection device 1100, an ignition device 1200, etc. The shift control of the belt type continuously variable transmission 500, the belt clamping pressure control, the engagement/release control of the forward clutch 406, and the engagement/release control of the reverse brake 410 are performed via a hydraulic control circuit 2000.

In this embodiment, if a fuel-cut execution condition that includes a condition that the engine rotation speed is greater than or equal to a predetermined fuel injection return rotation speed and a condition that the accelerator operation amount is less than or equal to a threshold value is satisfied, the ECU 900 executes the fuel-cut control to stop the injection of fuel by the fuel injection device 1100.

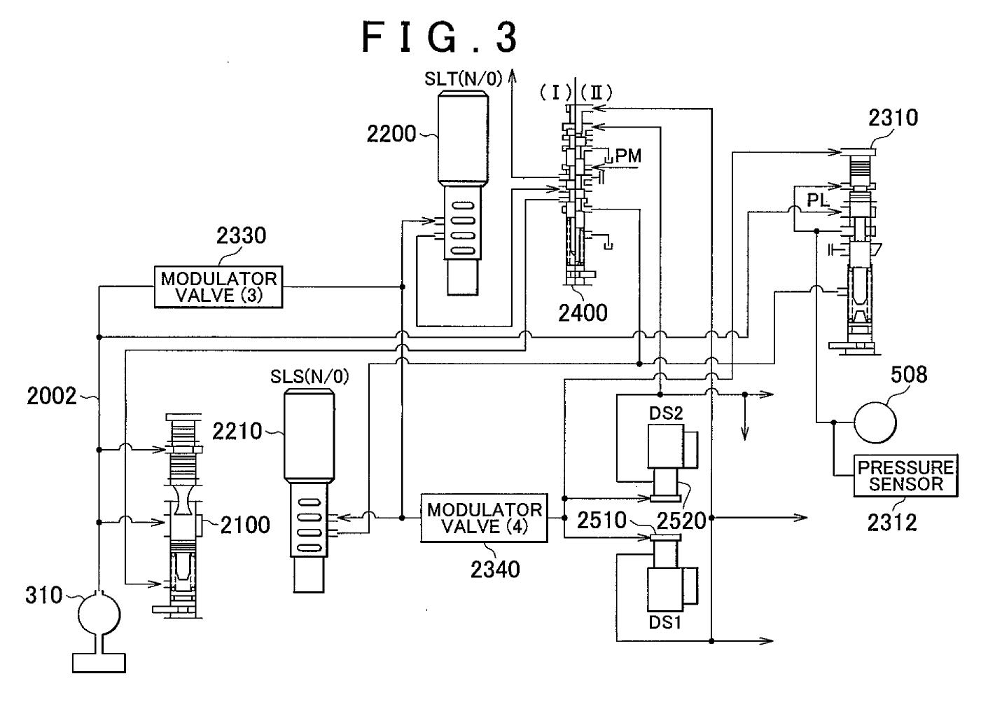

With reference to FIG. 3, a portion of the hydraulic control circuit 2000 will be described. The oil pressure generated by the oil pump 310 is supplied to a primary regulator valve 2100, a modulator valve (1) 2310, and a modulator valve (3) 2330 via a line pressure oil passageway 2002.

The primary regulator valve 2100 is supplied with a control pressure selectively from one of an SLT linear solenoid valve 2200 and an SLS linear solenoid valve 2210. In this embodiment, both the SLT linear solenoid valve 2200 and the SLS linear solenoid valve 2210 are normally-open solenoid valves (in which the output oil pressure is at a maximum when not electrified). Alternatively, the SLT linear solenoid valve 2200 and the SLS linear solenoid valve 2210 may also be normally closed solenoid valves (in which the output oil pressure becomes minimum (“0”) when not electrified).

A spool of the primary regulator valve 2100 slides up and down in accordance with the supplied control pressure. In this manner, the oil pressure generated by the oil pump 310 is regulated (adjusted) by the primary regulator valve 2100. The oil pressure regulated by the primary regulator valve 2100 is used as a line pressure PL. In this embodiment, the higher the control pressure supplied to the primary regulator valve 2100, the higher the line pressure PL becomes. It is also allowable that the higher the control pressure supplied to the primary regulator valve 2100, the lower the line pressure PL become.

The SLT linear solenoid valve 2200 and the SLS linear solenoid valve 2210 are supplied with an oil pressure provided by the modulator valve (3) 2330 regulating the line pressure PL as a basic pressure.

The SLT linear solenoid valve 2200 and the SLS linear solenoid valve 2210 each generate control pressure in accordance with a current value that is determined by a duty signal sent from the ECU 900.

Of the control pressure (output pressure) of the SLT linear solenoid valve 2200 and the control pressure (output pressure) of the SLS linear solenoid valve 2210, the control pressure supplied to the primary regulator valve 2100 is selected by a control valve 2400.

When a spool of the control valve 2400 is in a state (I) (a state shown on the left side) in FIG. 3, the control pressure is supplied from the SLT linear solenoid valve 2200 to the primary regulator valve 2100. That is, the line pressure PL is controlled in accordance with the control pressure of the SLT linear solenoid valve 2200.

When the spool of the control valve 2400 is in a state (II) (a state shown on the right side) in FIG. 3, the control pressure is supplied from the SLS linear solenoid valve 2210 to the primary regulator valve 2100. That is, the line pressure PL is controlled in accordance with the control pressure of the SLS linear solenoid valve 2210.

In addition, when the spool of the control valve 2400 is in the state (II) in FIG. 3, the control pressure of the SLT linear solenoid valve 2200 is supplied to a manual valve 2600 described later.

The spool of the control valve 2400 is urged in one direction by a spring. In order to counteract this elastic force of the spring, oil pressure is supplied from a shift-control duty solenoid (1) 2510 and a shift-control duty solenoid (2) 2520.

When oil pressure is supplied from both the shift-control duty solenoid (1) 2510 and the shift-control duty solenoid (2) 2520 to the control valve 2400, the spool of the control valve 2400 is in the state (II) shown in FIG. 3.

When the oil pressure from at least one of shift-control duty solenoid (1) 2510 and the shift-control duty solenoid (2) 2520 is not supplied to the control valve 2400, the spool of the control valve 2400 is in the state (1) shown in FIG. 3 due to the elastic force of the spring.

The shift-control duty solenoid (1) 2510 and the shift-control duty solenoid (2) 2520 are supplied with oil pressure regulated by the modulator valve (4) 2340. The modulator valve (4) 2340 regulates the oil pressure supplied from the modulator valve (3) 2330 to a constant pressure.

The modulator valve (1) 2310 outputs oil pressure provided by regulating the line pressure PL as a basic pressure. The oil pressure output from the modulator valve (1) 2310 is supplied to the hydraulic cylinder of the secondary pulley 508. The hydraulic cylinder of the secondary pulley 508 is supplied with sufficient oil pressure that the transmission belt 510 does not slip.

The modulator valve (1) 2310 is provided with a spool that is movable in the directions of the axis of the modulator valve, and a spring that urges the spool in one direction. The modulator valve (1) 2310 regulates the line pressure PL introduced into the modulator valve (1) 2310 by using as a pilot pressure the output pressure of the SLS linear solenoid valve 2210 that is duty-controlled by the ECU 900. The oil pressure regulated by the modulator valve (3) is supplied to the hydraulic cylinder of the secondary pulley 508. The belt clamping pressure is increased or decreased in accordance with the output pressure of the modulator valve (1) 2310.

The SLS linear solenoid valve 2210 is controlled to provide a belt clamping pressure that does not cause belt slippage, in accordance with a map in which the accelerator operation amount A(CC) and the speed change ratio GR are used as parameters. Concretely, the exciting current to the SLS linear solenoid valve 2210 is controlled with a duty ratio that corresponds to the belt clamping pressure. In addition, in the case where the transmission torque sharply changes at the time of acceleration and deceleration or the like, the belt clamping pressure may be corrected in the increasing direction to restrain the belt slippage.

The oil pressure supplied to the hydraulic cylinder of the secondary pulley 508 is detected by a pressure sensor 2312.

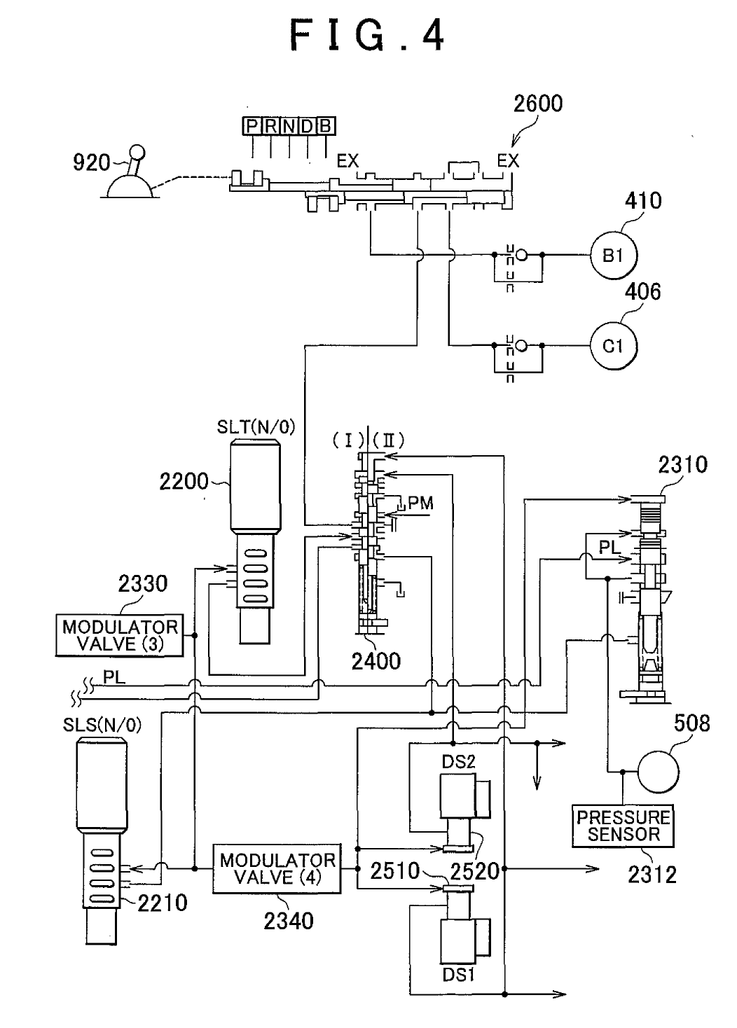

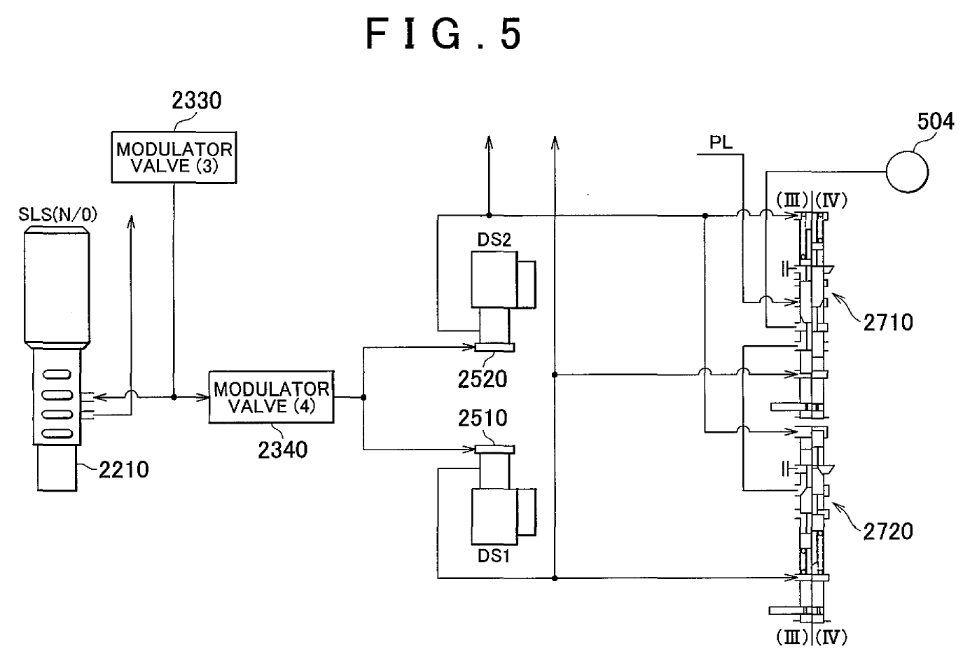

With reference to FIG. 4, the manual valve 2600 will be described. The manual valve 2600 is mechanically switched in accordance with the operation of the shift lever 920. Due to this, the forward clutch 406 and the reverse brake 410 are engaged or released.

The shift lever 920 is moved to the “P” position for parking, the “R” position for reverse, the “N,” position of shutting off the power transmission, and the “D” position and the “B” position for forward running.

At the “P” position and the “N,” position, the oil pressure in the forward clutch 406 and the reverse brake 410 is drained through the manual valve 2600. As a result, the forward clutch 406 and the reverse brake 410 are released.

At the “R” position, oil pressure is supplied from the manual valve 2600 to the reverse brake 410. This engages the reverse brake 410. On the other hand, the oil pressure in the forward clutch 406 is drained through the manual valve 2600. This releases the forward clutch 406.

When the control valve 2400 is in a state (I) (a state shown on the left side) in FIG. 4, the modulator pressure PM from a modulator valve (2) (not shown) is supplied to the manual valve 2600 via the control valve 2400. This modulator pressure PM holds the reverse brake 410 in the engaged state.

When the control valve 2400 is in a state (II) (a state shown on the right side) in FIG. 4, the oil pressure regulated by the SLT linear solenoid valve 2200 is supplied to the manual valve 2600. By regulating the oil pressure via the SLT linear solenoid valve 2200, the reverse brake 410 is gently engaged to restrain shock at the time of engagement.

At the “D” position and the “B” position, oil pressure is supplied from the manual valve 2600 to the forward clutch 406. This engages the forward clutch 406. On the other hand, the oil pressure in the reverse brake 410 is drained through the manual valve 2600. This releases the reverse brake 410.

If the control valve 2400 is in the state (1) (the state shown on the left side) in FIG. 4, the modulator pressure PM from the modulator valve (2) (not shown) is supplied to the manual valve 2600 via the control valve 2400. This modulator pressure PM causes the forward clutch 406 to become engaged.

If the control valve 2400 is in the state (II) (the state shown on the right side) in FIG, 4, the oil pressure regulated by the SLT linear solenoid valve 2200 is supplied to the manual valve 2600. By regulating the oil pressure via the SLT linear solenoid valve 2200, the forward clutch 406 is gently engaged to restrain shock at the time of engagement.

Ordinarily, the SLT linear solenoid valve 2200 controls the line pressure PL via the control valve 2400. Ordinarily, the SLS linear solenoid valve 2210 controls the belt clamping pressure via the modulator valve (1) 2310.

On the other hand, when a neutral control execution condition that includes a condition that the vehicle has stopped (the vehicle speed has become “0”) with the shift lever 920 being at the “D” position is met, the SLT linear solenoid valve 2200 controls the engagement force of the forward clutch 406 so that the engagement force of the forward clutch 406 decreases. The SLS linear solenoid valve 2210 controls the belt clamping pressure via the modulator valve (1) 2310, and also controls the line pressure PL in substitute for the SLT linear solenoid valve 2200.

When a garage shift is performed in which the shift lever 920 is operated from the “N” position to the “D” position or the “CR” position, the SLT linear solenoid valve 2200 controls the engagement force of the forward clutch 406 or the reverse brake 410 so that the forward clutch 406 or the reverse brake 410 gently engages. The SLS linear solenoid valve 2210 controls the belt clamping pressure via the modulator valve (1) 2310, and also controls the line pressure PL in substitute for the SLT linear solenoid valve 2200.

With reference to FIG. 5, a construction for performing the shift control will be described. The shift control is performed by controlling the supply and discharge of the oil pressure with respect to the hydraulic cylinder of the primary pulley 504. The supply and discharge of working oil with respect to the hydraulic cylinder of the primary pulley 504 is performed through the use of a ratio control valve (1) 2710 and a ratio control valve (2) 2720.

The ratio control valve (1) 2710 supplied with the line pressure PL, and the ratio control valve (2) 2720 connected to the drain are connected in communication with the hydraulic cylinder of the primary pulley 504.

The ratio control valve (1) 2710 is a valve for executing upshift. The ratio control valve (1) 2710 is constructed so that a channel between an input port that is supplied with the line pressure PL and an output port connected in communication with the hydraulic cylinder of the primary pulley 504 is opened and closed by a spool.

A spring is disposed one end of the spool in the ratio control valve (1) 2710. A port that is supplied with the control pressure from the shift-control duty solenoid (1) 2510 is formed in the end portion distal from the spring disposed on the end portion of the spool. Aport that is supplied with the control pressure from the shift-control duty solenoid (2) 2520 is formed in the end where the spring is disposed.

When the control pressure from the shift-control duty solenoid (1) 2510 is increased and the output of the control pressure from the shift-control duty solenoid (2) 2520 is interrupted, the spool of the ratio control valve (1) 2710 assumes a state (IV) (a state shown on the right side) in FIG. 5.

In this state, the oil pressure supplied to the hydraulic cylinder of the primary pulley 504 increases, so that the groove width of the primary pulley 504 narrows. Therefore, the speed change ratio declines. That is, an upshift occurs. Besides, by increasing the supply flow rate of working oil at that time, the shifting speed becomes faster.

The ratio control valve (2) 2720 is a valve for executing downshift. A spring is disposed at one end of the ratio control valve (2) 2720. A port that is supplied with the control pressure from the shift-control duty solenoid (1) 2510 is formed in the end where the spring is disposed. A port that is supplied with the control pressure from shift-control duty solenoid (2) 2520 is formed in the end distal from the spring disposed on the end of the spool.

When the control pressure from the shift-control duty solenoid (2) 2520 increased and the output of the control pressure from the shift-control duty solenoid (1) 2510 is interrupted, the spool of the ratio control valve (2) 2720 assumes a state (III) (a state shown on the left side) in FIG. 5. Simultaneously, the spool of the ratio control valve (1) 2710 assumes a state (III) (a state shown on the left side) in FIG. 5.

In this state, the working oil is discharged from the hydraulic cylinder of the primary pulley 504 via the ratio control valve (1) 2710 and the ratio control valve (2) 2720. Therefore, the groove width of the primary pulley 504 widens. In consequence, the speed change ratio increases. That is, a downshift occurs. Besides, by increasing the discharge flow rate of working oil, the shifting speed becomes faster.

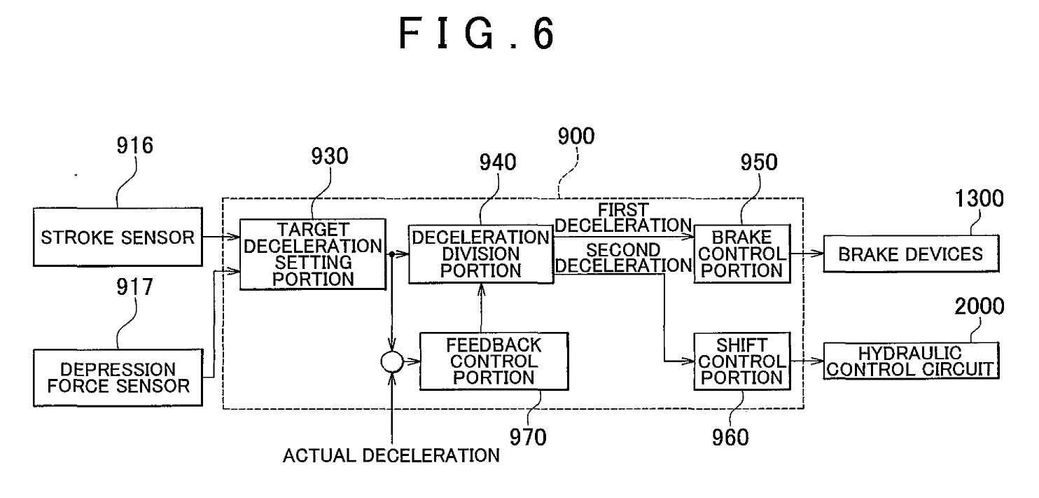

With reference to FIG. 6, the ECU 900 will be further described. The ECU 900 includes a target deceleration setting portion 930, a deceleration division portion 940, a brake control portion 950, a shift control portion 960, and a feedback control portion 970.

The target deceleration setting portion 930 sets a target deceleration of the vehicle on the basis of at least one of the amount of operation of the brake pedal detected by the stroke sensor 916 and the depression force of the brake pedal detected by the depression force sensor 917. The target deceleration is set, for example, in accordance with a map created beforehand through the use of the amount of operation of the brake pedal or the depression force thereof as a parameter. The greater the amount of operation or the depression force of the brake pedal, the smaller the target deceleration is set. Incidentally, in this embodiment, the deceleration is expressed as a negative value. The smaller the deceleration, the greater the braking force.

The deceleration division portion 940 divides the target deceleration into a first deceleration and a second deceleration. Specifically, the deceleration division portion 940 sets the first deceleration and the second deceleration so that the sum of the first deceleration and the second deceleration equals the target deceleration.

The “first deceleration” herein means the deceleration caused by the brake devices 1300. The “second deceleration” means the deceleration caused by the power train 100.

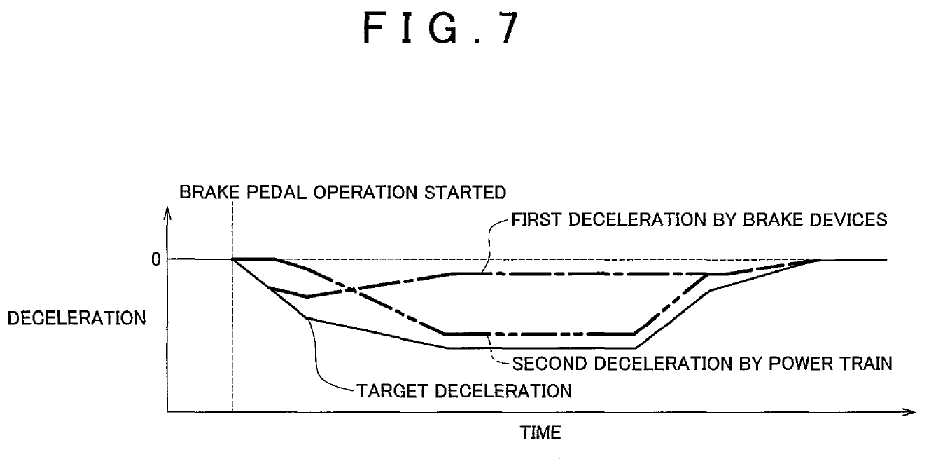

As shown in FIG. 7, immediately after the brake pedal is operated, the first deceleration by the brake devices 1300 and the second deceleration by the power train 100 are set so that the first deceleration is smaller than the second deceleration (i.e., so that the braking force caused by the brake devices 1300 is greater than the braking force caused by the power train 100). This setting is adopted because the braking by the brake devices 1300 is more responsive than the braking by the power train 100. The responsiveness is judged from parameters, such as a time constant TB and a lag time LB in the primary delay system of the brake devices 1300, and a time constant TT and a lag time LT of the primary delay system of the power train 100, etc.

After the first deceleration and the second deceleration are set so that the first deceleration is smaller than the second deceleration, the first deceleration is enlarged (i.e., the braking force caused by the brake devices 1300 is reduced) as the second deceleration lessens (i.e., as the braking force caused by the power train 100 increases).

Referring to FIG. 6, the brake control portion 950 controls the brake devices 1300 to generate a braking force that realizes the first deceleration. The brake devices 1300 are controlled in accordance with a map created beforehand through the use of the deceleration as a parameter.

The shift control portion 960 calculates an appropriate speed change ratio that provides the amount of braking force required by the second deceleration, and controls the belt type continuously variable transmission 500 via the hydraulic control circuit 2000 to achieve the calculated speed change ratio. The speed change ratio is calculated from a map created beforehand through the use of the deceleration as a parameter. The speed change ratio is calculated so that the smaller the second deceleration (the greater the braking force), the greater the speed change ratio becomes.

The feedback control portion 970 calculates the deviation between the target deceleration and the actual deceleration, and corrects the first deceleration and the second deceleration based on the deviation.

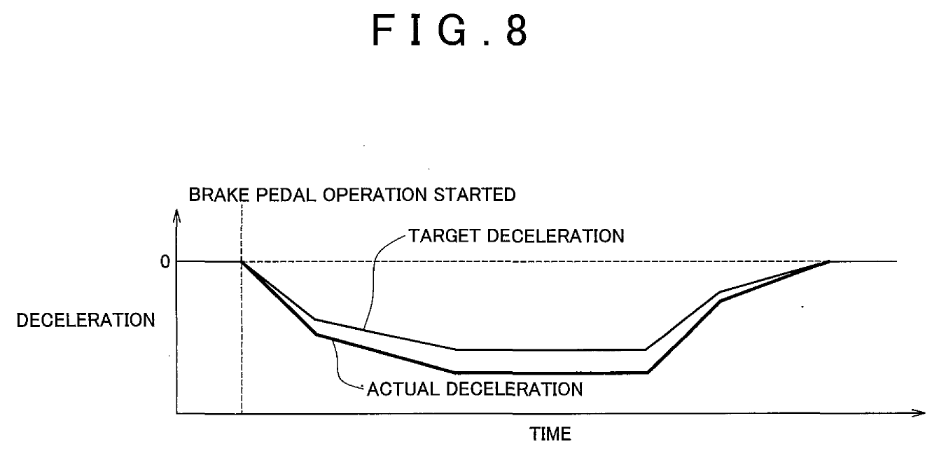

As shown in FIG. 8, if the target deceleration is greater than the actual deceleration, that is, when the actual braking force is excess, correction is made so that at least one of the first deceleration and the second deceleration enlarges.

At this time, the first deceleration by the brake devices 1300 is preferentially enlarged. If the first deceleration cannot be enlarged, or if enlarging the first deceleration cannot eliminate the deviation between the target deceleration and the actual deceleration, the second deceleration is enlarged. Specifically, the speed change ratio is decreased to reduce the braking force.

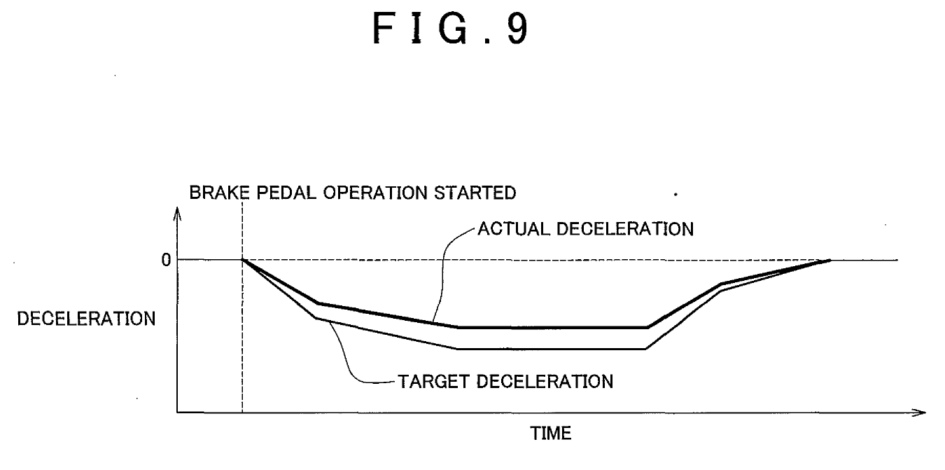

As shown in FIG. 9, when the target deceleration is smaller than the actual deceleration, that is, when the actual braking force is insufficient, correction is made so that at least one of the first deceleration and the second deceleration lessens.

At this time, the first deceleration by the brake devices 1300 is lessened prior to the second deceleration. After that the second deceleration is lessened, and at the same time, the first deceleration is enlarged so that the deviation between the target deceleration and the actual deceleration is minimized.

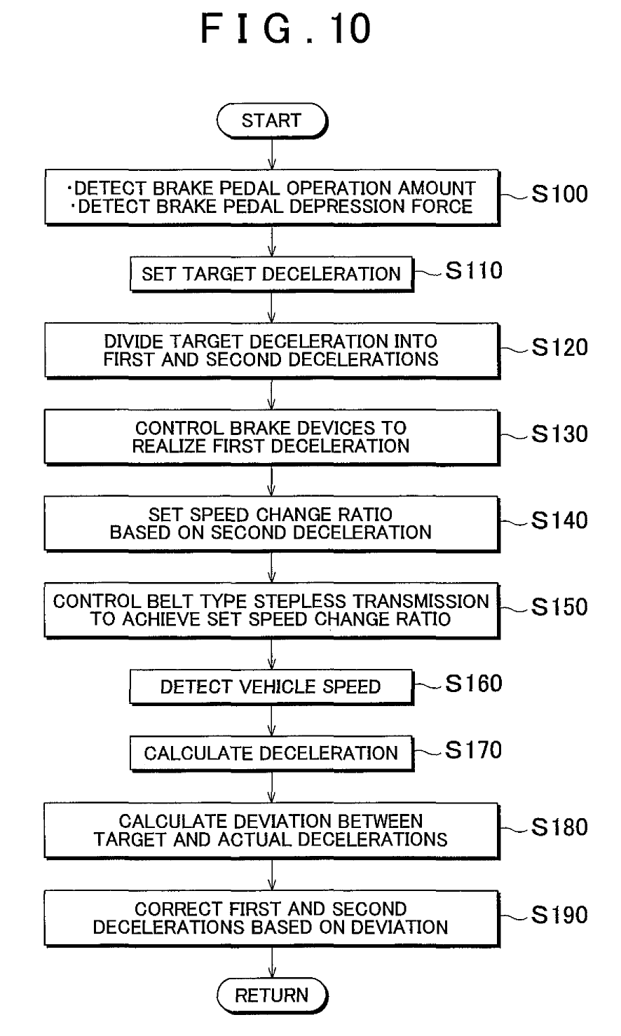

With reference to FIG. 10, a control structure of a program executed by the ECU 900 of the control device in accordance with the embodiment will be described. In addition, the program described below is continuously executed at predetermined intervals.

In step (hereinafter, the step is abbreviated to “S”) S100, the ECU 900 detects the amount of operation of the brake pedal on the basis of the signal sent from the stroke sensor 916, and detects the depression force of the brake pedal on the basis of the signal sent from the depression force sensor 917.

In S110, the ECU 900 sets a target deceleration of the operation vehicle on the basis of at least one of the amount of operation and the depression force of the brake pedal.

In S120, the ECU 900 divides the target deceleration of the vehicle into the first deceleration caused by the braking force of the brake devices 1300, and the second deceleration caused by the braking force of the power train 100.

S130, the ECU 900 controls the brake devices 1300 to realize the first deceleration. In S140, the ECU 900 sets a speed change ratio of the belt type continuously variable transmission 500 on the basis of the second deceleration. In S150, the ECU 900 controls the belt type continuously variable transmission 500 to achieve the speed change ratio.

In S160, the ECU 900 detects the vehicle speed on the basis of the signal sent from the vehicle speed sensor 906. In S170, the ECU 900 calculates the actual deceleration of the vehicle by differentiating the vehicle speed with time.

In 5180, the ECU 900 calculates the deviation between the target deceleration and the actual deceleration. In S190, the ECU 900 corrects the first deceleration and the second deceleration on the basis of the deviation between the target deceleration and the actual deceleration.

The operation of the ECU 900, which is the control device in accordance with the embodiment, based on the structure and the flow described above, will be described.

When the vehicle is moving, the amount of operation of the brake pedal is detected on the basis of the signal sent from the stroke sensor 916, and the depression force of the brake pedal is detected on the basis of the signal sent from the depression force sensor 917 (S100). A target deceleration in accordance with at least one of the detected amount of operation and the detected depression force of the brake pedal is set (S110).

The brake devices 1300 and the power train 100 are controlled to achieve the target deceleration. At this time, if the vehicle is decelerated by using only the brake devices 1300, the amount of energy dissipated as heat energy is great. Therefore, it is preferable to actively use the braking force caused by the power train 100 in addition to the braking force caused by the brake devices 1300.

Therefore, the set target deceleration is divided into the first deceleration caused by the braking force of the brake devices 1300 and the second deceleration caused by the braking force of the power train 100 (S120).

As described above, immediately after the brake pedal is operated, the first deceleration by the brake devices 1300 and the second deceleration by the power train 100 are set so that the first deceleration is smaller than the second deceleration (i.e., so that the braking force caused by the brake devices 1300 is greater than the braking force caused by the power train 100). After that, the first deceleration is enlarged (i.e., the braking force caused by the brake devices 1300 is reduced) as the second deceleration lessens (i.e., as the braking force caused by the power train 100 increases).

The brake devices 1300 are controlled to realize the first deceleration (S130). In addition, a speed change ratio to realize the second deceleration is also set (S140). At this time, the smaller the second deceleration, the higher the speed change ratio is set. The belt type continuously variable transmission 500 is controlled to achieve the speed change ratio (S150).

Therefore, immediately after the brake pedal is operated, the braking force of the brake devices 1300, which are more responsive, is increased so that the vehicle can be promptly decelerated. After that, the braking force of the brake devices 1300 is reduced and, instead, the braking force of the power train 100 is increased so that the energy dissipated as heat energy by the brake devices 1300 can be lessened while the target deceleration is maintained.

In the belt type continuously variable transmission 500, the greater the second deceleration, the higher the speed change ratio is set. Therefore, the engine rotation speed can be increased by using kinetic energy of the vehicle during deceleration. Therefore, it is possible to facilitate the continuation of a state where the engine rotation speed NE is greater than or equal to the predetermined fuel injection return rotation speed during deceleration. Consequently, the time during which the fuel-cut can be executed may be lengthened, improving fuel economy.

Incidentally, the actual deceleration does not always become equal to the target deceleration. Therefore, the vehicle speed is detected on the basis of the signal sent from the vehicle speed sensor 906 (S160), and the actual deceleration of the vehicle is calculated by differentiating the detected vehicle speed with time (S170). Furthermore, the deviation between the target deceleration and the actual deceleration is calculated (S180). On the basis of the calculated deviation, the first deceleration and the second deceleration are corrected (S190).

As described above, when the target deceleration is greater than the actual deceleration, that is, when the actual braking force is excessive, the first deceleration caused by the brake devices 1300 is enlarged preferentially over the second deceleration. Therefore, the braking force of the brake devices 1300 is reduced. Therefore, the energy dissipated as heat energy can be lessened.

When the target deceleration is lower than the actual deceleration, that is, if the braking force is insufficient, the first deceleration by the brake devices 1300 is lessened prior to the second deceleration by the power train 100. Therefore, the actual deceleration is promptly brought close to the target deceleration using the brake devices 1300, which are good in the responsiveness with regard to deceleration.

After that, as the second deceleration is lessened, the first deceleration is enlarged so that the deviation between the target deceleration and the actual deceleration remains minimal. Therefore, the braking force of the brake devices 1300 can be reduced. Consequently, the energy dissipated as heat energy can be lessened.

As described above, according to the ECU that is the control device in accordance with the embodiment, the target deceleration is set in accordance with at least one of the amount of operation of the brake pedal and the depression force thereof. The set target deceleration is divided into the first deceleration caused by the braking force of the brake devices and the second deceleration caused by the braking force of the power train. The brake devices are controlled to achieve the first deceleration. The belt type continuously variable transmission constituting the power train is controlled to change to an appropriate speed change ratio to achieve the second deceleration. Therefore, the vehicle is decelerated using both the brake devices and the power train. Consequently, the energy dissipated as heat energy by the brake devices is reduced.

Although in this embodiment, the target deceleration is set in accordance with at least one of the amount of operation and the depression force of the brake pedal, it is also allowable to set the braking force instead of the target deceleration. In this case, the set braking force may be divided into a braking force of the brake devices 1300 and a braking force of the power train 100.

It is to be understood that the embodiments disclosed in this application are not restrictive but illustrative in all respects. The scope of the invention is shown not by the foregoing description but by the claims for patent, and is intended to cover all modifications within the meaning and scope equivalent to the claims for patent.

What is claimed is:

1. A control device for a vehicle that includes:
a power train that transmits drive force output from a power source to a wheel via an automatic transmission; and
a braking mechanism that restrains rotation of the wheel by friction force, the control device comprising:
a setting device that sets a physical amount representing a degree of deceleration of the vehicle, in accordance with an operation of a brake pedal;
a division device that divides the physical amount set by the setting device into a first physical amount that represents the degree of deceleration of the vehicle caused by the braking mechanism and a second physical amount that represents the degree of deceleration of the vehicle caused by the power train;
a first control portion that controls the braking mechanism to satisfy the first physical amount; and
a second control portion that controls the transmission to satisfy the second physical amount.

2. The control device for the vehicle according to claim 1, wherein the second control portion includes means for controlling the automatic transmission to achieve a speed change ratio that satisfies the second physical amount.

3. The control device for the vehicle according to claim 2, wherein the automatic transmission is a continuously variable transmission.

4. The control device for the vehicle according to of claim 2, wherein:
the power source is an internal combustion engine; and
the control device further comprises stop device for stopping fuel supply in the internal combustion engine if rotation speed of the internal combustion engine is greater than or equal to a predetermined value.

5. The control device for the vehicle according to claim 2, wherein the division device includes device that divides the physical amount set by the setting device into the first physical amount and the second physical amount so that the degree of deceleration of the vehicle caused by the braking mechanism is smaller than the degree of deceleration of the vehicle caused by the power train, and then dividing the physical amount set by the setting device into the first physical amount and the second physical amount so that the degree of deceleration of the vehicle caused by the braking mechanism is increased while the degree of deceleration of the vehicle caused by the power train is decreased.

6. A control method for a vehicle comprising:
setting a physical amount that represents a degree of deceleration of the vehicle, in accordance with an operation of a brake pedal;
dividing the physical amount set into a first physical amount that represents the degree of deceleration of the vehicle caused by a braking mechanism that restrains rotation of a wheel by using friction force, and a second physical amount that represents the degree of deceleration of the vehicle caused by a power train that transmits drive force output from a power source to the wheel via a transmission;
controlling the braking mechanism to satisfy the first physical amount; and
controlling the transmission to satisfy the second physical amount.
